(19) United States
(12) Patent Application Publication
(10) Pub. No.: US 2019/0164092 A1
(43) Pub. Date: May 30, 2019

(54) DETERMINING RISK ASSESSMENT BASED ON ASSIGNED PROTOCOL VALUES

(71) Applicant: International Business Machines Corporation, Armonk, NY (US)

(72) Inventors: Kelly A. Argyros, Fairfax, VA (US); Daniel J. Ferranti, Washington, DC (US); Florian Pinel, New York, NY (US); Andrew S. H. Ting, Washington, DC (US); Joan W. Tomlinson, Alexandria, VA (US)

(21) Appl. No.: 15/822,811

(22) Filed: Nov. 27, 2017

(51) Int. Cl. G06Q 10/06; G06F 17/30; G06F 15/18; G06F 3/0482; G06F 9/44

(52) U.S. Cl. CPC G06Q 10/0635; G06F 17/30896; G06F 8/38; G06F 15/18; G06F 3/0482; G06F 17/30551

(57) ABSTRACT

A protocol user interface (UI) element on a graphical user interface is generated, in which the protocol UI element includes an input field and is assigned with a weight value. The weight value is determined at least based upon data entered into the input field of the protocol UI element. The weight value assigned to the protocol UI element is adjusted based on historical event data associated with a protocol corresponding to the protocol UI element. Data entered into the input field of the protocol UI element is parsed. A risk assessment score based on the adjusted weight value and parsed data is dynamically calculated, in which the risk assessment score indicates a likelihood that an adverse event will occur as a result of violating the protocol.

### TECHNICAL FIELD

The present invention relates generally to a method, system, and computer program product for real-time data management of enterprise software. More particularly, the present invention relates to a method, system, and computer program product for dynamically determining risk assessment based on assigned protocol values of the enterprise software based on historical data.

### BACKGROUND

Historical analytics refers to the analysis of activity and data from the past to discern particular trends, patterns, correlations, and other statistical relationships that may drive insight into business performance. At times, data obtained from historical analytics may be applied to existing enterprise software systems, in order to ensure that operational activities of organizations are optimized to generate better results and minimize risk.

Risk Management is the process of measuring or assessing risk and developing strategies to manage it. Strategies include transferring the risk to another party, avoiding the risk, reducing the negative effect of the risk, and accepting some or all of the consequences of a particular risk. Traditional risk management focuses on risks stemming from physical causes (e.g. natural disasters or fires, accidents and death). Financial regulatory risk management, on the other hand, focuses on risks that can be managed using financial controls and legal and regulatory historical event data.

### SUMMARY OF THE INVENTION

The illustrative embodiments provide a method, system, and computer program product. An aspect of the present invention generates a protocol user interface (UI) element on a graphical user interface, wherein the protocol UI element includes an input field and is assigned with a weight value. The weight value is determined at least based upon data entered into the input field of the protocol UI element. The aspect of the present invention adjusts the weight value assigned to the protocol UI element based on historical event data associated with a protocol corresponding to the protocol UI element. The aspect of the present invention parses data entered into the input field of the protocol UI element. The aspect of the present invention dynamically calculates a risk assessment score based on the adjusted weight value and parsed data, wherein the risk assessment score indicates a likelihood that an adverse event will occur as a result of violating the protocol.

An aspect of the present invention includes a computer program product. The computer program product includes one or more computer-readable storage devices, and program instructions stored on at least one of the one or more storage devices.

An aspect of the present invention includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example of determining risk assessment based on assigned protocol values in accordance with an illustrative embodiment;

FIG. 4 depicts a diagram of an example interface of determining risk assessment based on assigned protocol values in accordance with an illustrative embodiment; and

FIG. 5 depicts a flowchart of an example process for determining risk assessment based on assigned protocol values in accordance with an illustrative embodiment.

### DETAILED DESCRIPTION OF THE EMBODIMENTS

Illustrative embodiments recognize that, in risk assessment software and systems, users manually select risk ratings in each protocol that an organization needs to be in compliance. Afterwards, the risk ratings are aggregated after which risk assessment software calculates an overall risk assessment rating calculated and available for comment within the protocol.

Illustrative embodiments further recognize that manual selection of risk ratings for each protocol can be inaccurate and subjective, and does not sufficiently address historical event data that may have an adverse impact on the organization. To examine each historical event data record manually to adjust ratings assigned to the protocols, the users may be forced to review massive amounts of data not only from internal databases but also third-party external databases. The illustrative embodiments recognize that there are different types of data that may affect how a protocol should be evaluated and rated.

Illustrative embodiments also recognize that risk assessment software and systems need the functionality of protocols to allows users to complete a risk assessment report thoroughly. Yet at the same time, illustrative embodiments require the capability to provide real-time results of calculations in order to allow users to address possible issues that may be raised by entering certain data into the input fields associated with the protocols.

The illustrative embodiments recognize that the presently available tools or solutions do not address the needs or provide adequate solutions for these needs. The illustrative embodiments used to describe the invention generally address and solve the above-described problems and other problems related to real-time and dynamic updates of enterprise operation data in large-scale information technology (IT) systems.

An embodiment can be implemented as a software application. The application implementing an embodiment can be configured as a modification of an existing software platform, as a separate application that operates in conjunction with an existing software platform, a standalone application, or some combinations thereof.

In one embodiment, rules and calculations, including weight values, are embedded in each protocol. Depending on the user's response to each protocol, the embodiment dynamically calculates risk assessment scores in real-time using the embedded rules and the weight values, which allows the user to address possible issues that may be raised by entering certain data into the input fields associated with the protocols.

In one embodiment, the weight values embedded in each protocol can be adjusted based on a record of various incidents that have previously occurred that relate to the protocol queries. In some embodiments, the record of various incidents (e.g., adverse events) may be retrieved from the organization's database. In other embodiments, the records may also be retrieved from outside sources and external databases such as Consumer Financial Protection Bureau consumer complaints database. In some embodiments, the record of various incidents can be parsed by natural language processing algorithms so that the weight values can be adjusted accordingly.

In one embodiment, the rules and weight values embedded in each protocol can be adjusted further through a set of machine learning algorithms, which provide a more accurate assessment of how the weight values should be adjusted. In some embodiments, missing records of various incidents can be taken into account by the machine learning algorithm, and the weight values are adjusted accordingly.

The illustrative embodiments are described with respect to certain types of protocols, machine learning systems, weighted values, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

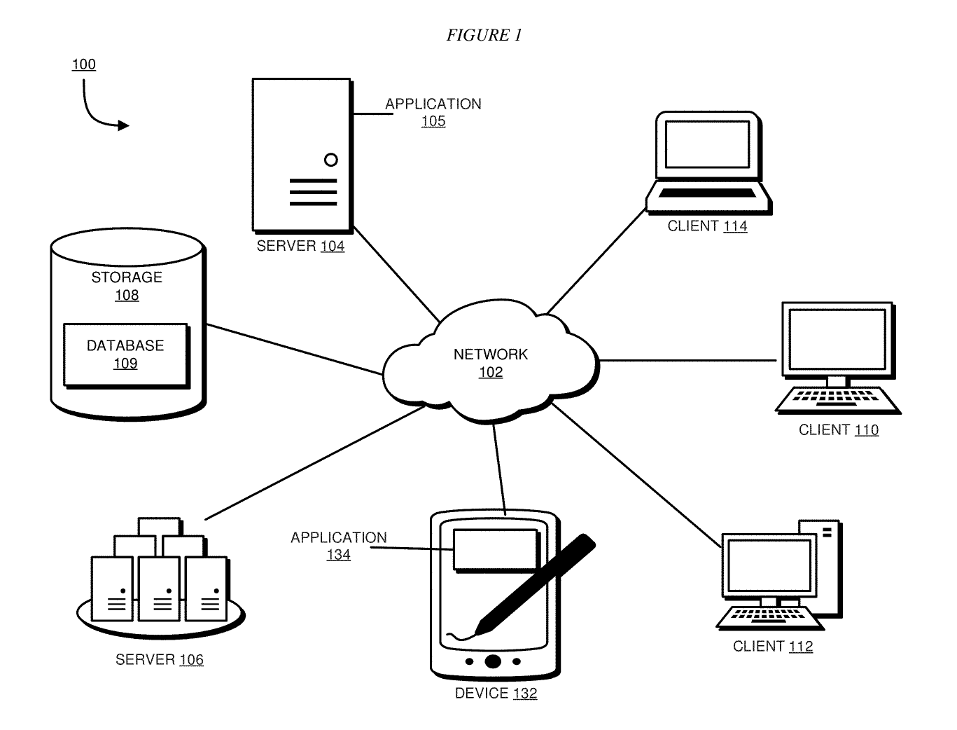

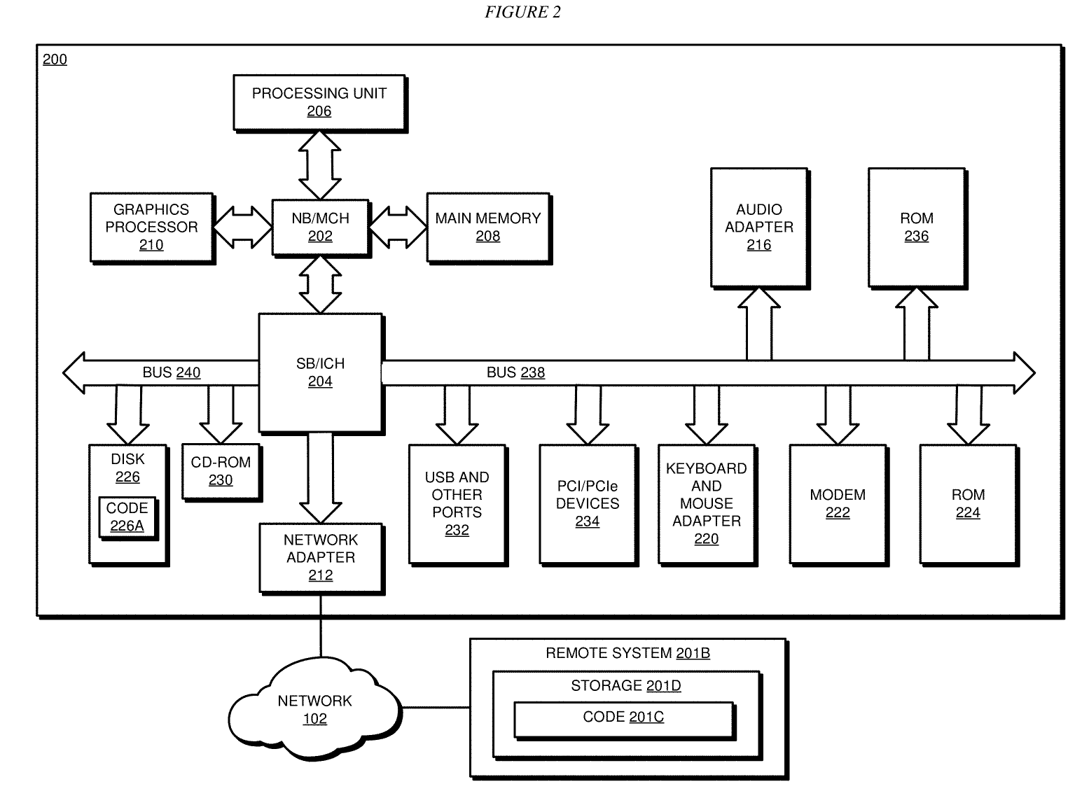

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

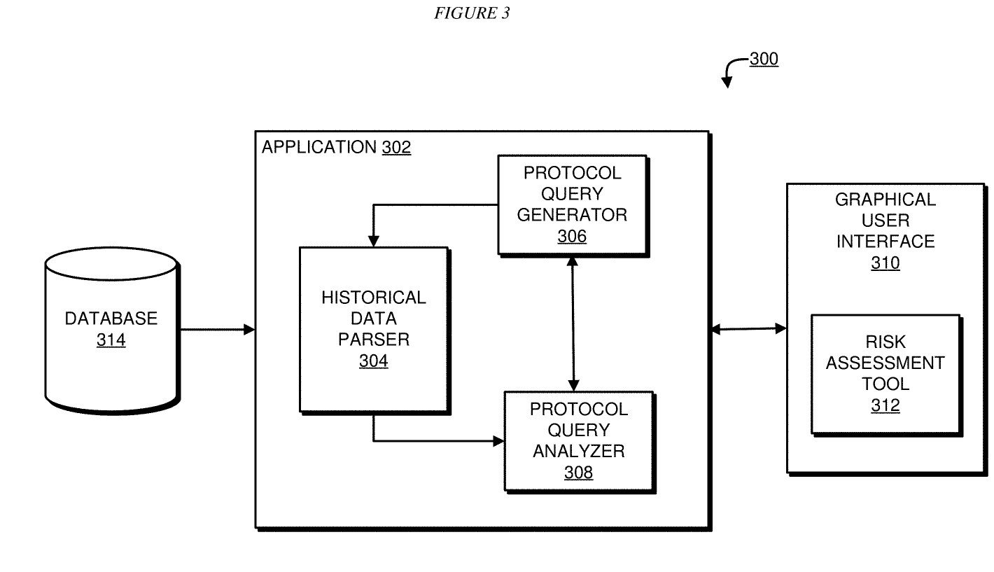

With reference to FIG. 3, this figure depicts an architecture diagram of an example of determining risk assessment based on assigned protocol values in accordance with an illustrative embodiment. Application 302 is an example of application 105 in FIG. 1.

In these embodiments, application 302 includes historical data parser 304, protocol query generator 306, and protocol query analyzer 308. Historical data parser 304 may perform any number of analytics algorithms, such as cross-referencing data, and correlating data, and/or performing any number of metrics calculations, using data records provided by database 314. Historical data parser 304 may require data to be defined by a schema file, according to domains or sub-domains. In some instances, historical data parser 304 may receive data tagged with any number of domain tags to cross-reference data records to generate data sets that can be consumed by protocol query analyzer 308. In some implementations, data domains may be associated with various domains, such as operational, compliance, regulatory, risk assessment and financial. The domains may contain subjects (i.e., data fields or collection of data fields) that specify the entities and dimensions for the analytics used for generating analytics-based reports for a given business domain.

In several embodiments, historical data parser 304 may retrieve data records from database 314 that relate to operational protocols. In one embodiment, data records may include risk assessment reports, which provide an overview of the risk exposure to an organization conducting certain types of business operations. In some embodiments, data records may include incident reports which describe adverse events experienced by an organization, including the cause of the adverse events, the severity of the adverse events, entities involved in the adverse events, and types of protocols violated in connection with the occurrence of the adverse events.

In some embodiments, historical data parser 304 receives these database records from database 314 and may perform natural language processing to be consumed by protocol query analyzer 308. In this embodiment, historical data parser 304 may parse various forms of the text corpus of data records and may output various analysis formats, including part-of-speech tagged text, phrase structure trees, and grammatical relations (typed dependency) format. In some embodiments, natural language processing algorithm can be trained through machine learning via a collection of syntactically annotated data such as the Penn Treebank. In one embodiment, historical data parser 304 may utilize lexicalized parsing to tokenize data records then construct a syntax tree structure of text tokens for each of data record. In another embodiment, historical data parser 304 may utilize dependency parsing to identifying grammatical relationships between each of the text tokens in each of the data records.

Protocol query generator 306 generates a set of protocol UI elements to be displayed on graphical user interface 310. For each protocol UI element, protocol query generator 306 associates a protocol description, at least one input field into which data can be entered, and at least one weight value assigned to the protocol. In some embodiments, protocol query generator 306 also associates a set of rules to the protocol UI element, wherein the set of rules can be implemented by risk assessment tool 312 to determine and/or adjust the risk assessment score. In several embodiments, input fields may include Hypertext Markup Language (HTML) elements including text boxes, radio buttons, drop down menus, buttons, and checkboxes. In some embodiments, one weight value may be assigned to the protocol. In other embodiments, two or more weight values may be assigned to the protocol, which protocol query generator 306 selects the appropriate weight value based on the data entered into the input field. For example, if the data entered into the input field is a “true” Boolean value in response to a protocol description, then protocol query generator 306 may select a first weight value (0.71), but if the data entered is “false” Boolean value, then protocol query generator 306 may select a second weight value (0.27). Protocol query generator 306 associates the selected weight value and the protocol, then provides the protocol-weight value attributes to protocol query analyzer 308 and/or risk assessment tool 312.

Protocol query analyzer 308 retrieves protocol-weight value attributes from protocol query generator 306, in which protocol query generator 306 continuously iterates through the set of protocol UI elements available in database 314 and provides the protocol as represented by the protocol UI element and its assigned weight value as inputs. In addition, protocol query analyzer 308 receives parsed content processed by historical data parser 304 that corresponds to the protocols as provided by protocol query generator 306. In one embodiment, protocol query analyzer 308 matches the protocols with the parsed content from historical data parser 304 so that the parsed content will only affect the applicable protocols. In some embodiments, protocols and parsed content may involve one-to-one relationship. In other embodiments, protocols and parsed content may involve one-to-many relationship.

In one embodiment, protocol query analyzer 308 uses a machine learning algorithm to compare the parsed content relating to the protocol from historical data parser 304 with the weight value attributes provided by protocol query generator 306. Based on the comparison, protocol query analyzer 308 assigns a coefficient value used to adjust the weight value assigned to the protocol. Protocol query analyzer 308 obtains the coefficient value based on the parsed content that differ from the previous data records used to generate the weight value. In some embodiments, the coefficient value may be generated by aggregating sub-coefficient values calculated from content retrieved from plurality of external and internal databases, including database 314, and subsequently processed historical data parser 304. In another embodiment, protocol query analyzer 308 may obtain the coefficient values based on parsed external, third-party records that correspond to the protocol. In some embodiments, the third-party records can be readily identified as the protocol was initially generated therefrom. In some embodiments, application 302 may extract metadata values of the protocol, including provenance information, then identify the relevant third-party records based on the metadata values. The identified third-party records can then be processed by historical data parser 304 so as to provide the relevant parsed content to be processed by protocol query analyzer 308. In some embodiments, updates to the existing third-party records can be detected by application 302, which activates historical data parser 304 to process the updated third-party records to ultimately determine whether the weight value assigned to the protocol should be adjusted accordingly.

In one embodiment, protocol query analyzer 308 adjusts the weight value based on the coefficient values that were generated. Protocol query analyzer 308 re-assigns the adjusted weight value to the protocol, which the updated protocol-weight value attributes are returned to protocol query generator 306.

In one embodiment, the risk assessment tool 312 may receive and utilize the selected weight value and any rules assigned to the protocol to calculate a set of risk assessment score for a plurality of operational risk categories. The risk assessment tool 312 may include a computer device configured to assess a risk associated with a business process. The risk management system may be communicatively coupled to the risk assessment system such that the risk management system may be configured to manage a business project for mitigating the risk associated with the business process. In some cases, risk assessment tool 312 may provide a user interface having at least one user interface screen, a processor communicatively coupled to the user interface, and a memory device communicatively coupled to the user interface and the processor. The memory device may store instructions, when executed by the processor, cause the risk assessment tool 312 to solicit risk information from a business unit about a process subject to a risk via a user interface screen and communicate the risk information to the risk assessment system via a network. The risk assessment system may determine a risk score associated with the process based on the risk information received from the business unit. The user, via a user interface screen of risk assessment tool 312, may provide approval of a risk management project for mitigating the risk associated with the process. The instructions may further cause the risk assessment tool 312 to communicate after approval has been granted, information about the risk management project to the risk management system and to solicit, via a user interface screen, a risk management decision about an approved risk management project. The risk management decision may include a choice between closing the risk management project, accepting the risk associated with the project and applying at least one control to the risk management project. In some cases, the at least one control may be designed to mitigate a risk identified by the risk assessment system. The risk assessment score is updated dynamically and presented in graphical user interface 310 in real-time as the data is entered into the input field of each protocol UI element.

Database 314 may be implemented through a relational database in which the records are organized into a tabular format, having rows and columns in which the corresponding information can be stored in a “structured” format. Examples of a relational database include SQL and IBM® DB2®. The records stored in a relational database can be retrieved by executing a query constructed through user input.

In other embodiments, database 314 may be a non-relational database such as NoSQL. A NoSQL database environment is a non-relational and largely distributed database system that enables rapid, ad-hoc organization and analysis of extremely high-volume, disparate data types. NoSQL databases are sometimes referred to as cloud databases, non-relational databases, Big Data databases and a myriad of other terms and were developed in response to the sheer volume of data being generated, stored and analyzed by modern users (user-generated data) and their applications (machine-generated data).

In general, NoSQL databases have become the first alternative to relational databases, with scalability, availability, and fault tolerance being key deciding factors. They go well beyond the more widely understood legacy, relational databases (such as Oracle, SQL Server, and DB2 databases) in satisfying the needs of today's modern business applications. A very flexible and schema-less data model, horizontal scalability, distributed architectures, and the use of languages and interfaces that are “not only” SQL typically characterize this technology. Contrary to misconceptions caused by its name, NoSQL does not prohibit structured query language (SQL). While it's true that some NoSQL systems are entirely non-relational, others simply avoid selected relational functionality such as fixed table schemas and join operations. For example, instead of using tables, a NoSQL database might organize data into objects, key/value pairs or tuples.

There are four general types of NoSQL databases, each with their own specific attributes:

Graph database—Based on graph theory, these databases are designed for data whose relations are well represented as a graph and has elements which are interconnected, with an undetermined number of relations between them. Examples include Neo4j and Titan.

Key-Value store—we start with this type of database because these are some of the least complex NoSQL options. These databases are designed for storing data in a schema-less way. In a key-value store, all of the data within consists of an indexed key and a value, hence the name. Examples of this type of database include Cassandra, DyanmoDB, Azure Table Storage (ATS), Riak, BerkeleyDB.

Column store—(also known as wide-column stores) instead of storing data in rows, these databases are designed for storing data tables as sections of columns of data, rather than as rows of data. While this simple description sounds like the inverse of a standard database, wide-column stores offer very high performance and a highly scalable architecture. Examples include HBase, BigTable, and HyperTable.

Document database—expands on the basic idea of key-value stores where “documents” contain more complex in that they contain data and each document is assigned a unique key, which is used to retrieve the document. These are designed for storing, retrieving, and managing document-oriented information, also known as semi-structured data. Examples include MongoDB and CouchDB.

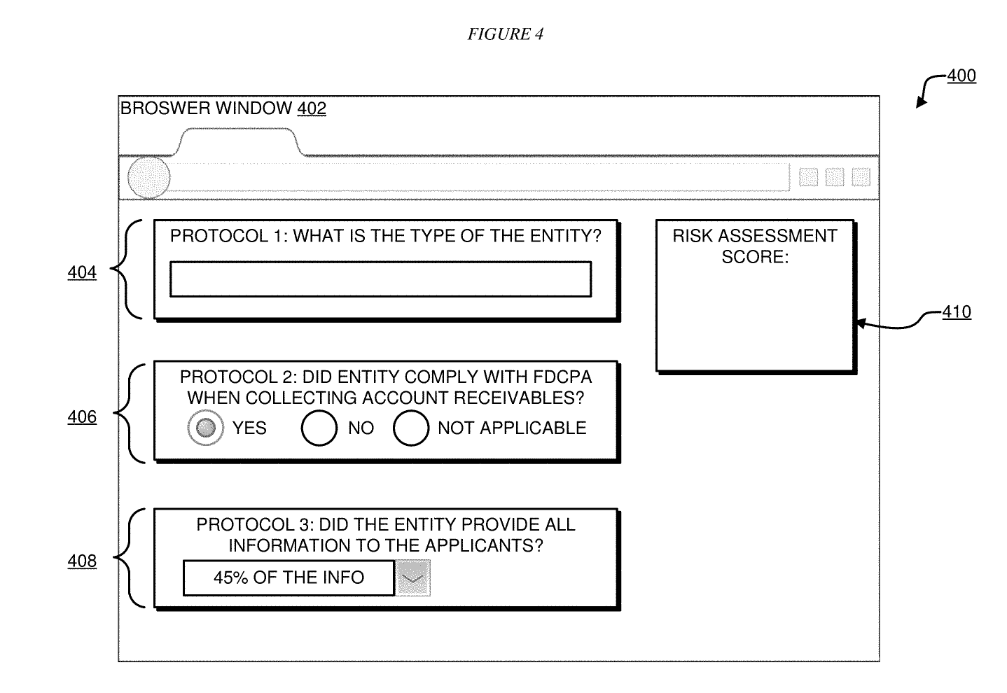

With reference to FIG. 4, this figure depicts an example interface of determining risk assessment based on assigned protocol values in accordance with an illustrative embodiment. Application 400 is an example of application 105 in FIG. 1 and application 302 in FIG. 3.

Application 400 displays a graphical user interface, e.g., browser window 402, which generates a set of interactive protocol UI elements 404, 406, and 408. Each of protocol UI elements 404, 406, and 408 includes a protocol description and an input field into which data can be entered. In one embodiment, protocol UI element 404 includes an input field that is a text box, protocol UI element 406 includes an input field that provides a set of radio buttons, and protocol UI element 408 includes a drop-down menu which the user can select the appropriate value. In several embodiments, weight values can be determined or calculated based on the data entered into the input fields. As the data is entered, application 400 dynamically calculates the risk assessment score based on the data entered into the input fields and displays the risk assessment score on risk assessment score element 410. For example, application 400 may generate a score of “medium risk” based on a weight value (0.34) assigned to “secured lending” data entered into the text box of protocol UI element 404. In another example, application 400 may generate a score of 78 indicative of high risk based on a weight value (0.81) assigned to “No” radio button of protocol UI element 406.

Although not shown, the weight values can be adjusted based on records of historical data of various incidents and adverse events that pertain to the protocol representative of protocol UI elements in accordance with the description set forth in FIG. 3.

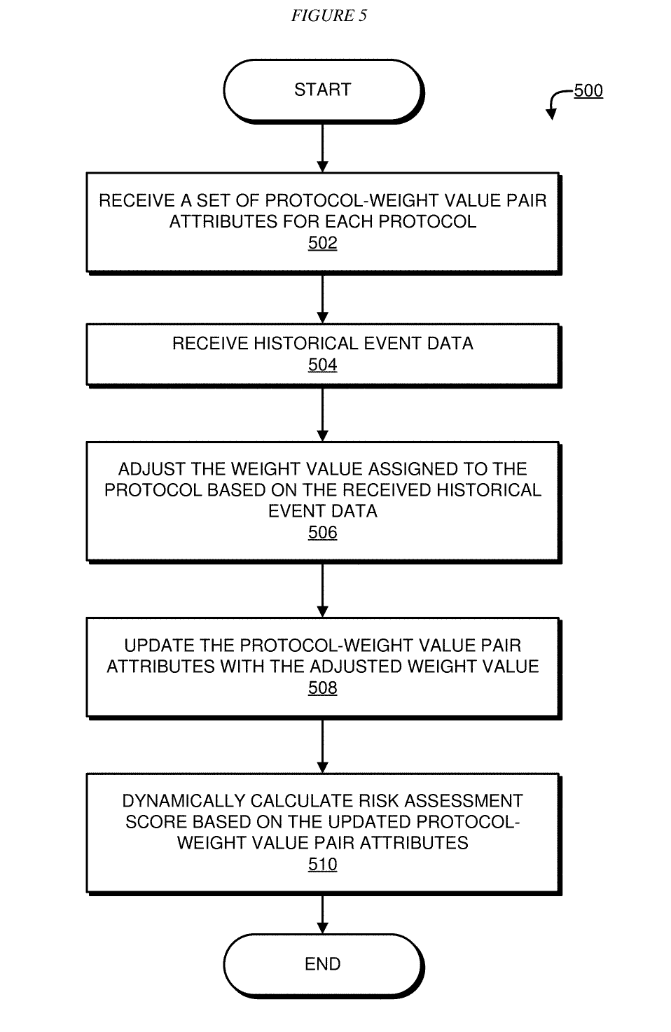

With reference to FIG. 5, this figure depicts a flowchart of an example process for determining risk assessment based on assigned protocol values in accordance with an illustrative embodiment. Process 500 may be implemented in application 302 in FIG. 3.

The application receives a set of protocol-weight value pair attributes for each protocol provided in the user interface (block 502). In one embodiment, the weight value can be determined by the data entered into the input field of the protocol UI element of the associated protocol. In some embodiments, the protocol can be further associated with a set of rules used to dynamically calculate the risk assessment score. The application receives historical event data from a database, e.g., database 314 (block 504). In one embodiment, natural language processing engines such as historical data parser 304 is used to parse and preprocess the historical event data.

The application adjusts the weight value assigned to the protocol based on the received historical event data (block 506). In some embodiments, the application first matches parsed historical event data with one or more applicable protocols, then adjusts the weight value assigned to that protocol. The application updates the protocol-weight value pair attributes with the adjusted weight value (block 508).

The application dynamically calculates risk assessment score based on the updated protocol-weight value pair attributes (block 510). In some embodiments, the application further calculates risk assessment score based on any set of rules assigned to the protocol. Process 500 terminates thereafter.

Thus, a computer implemented method, system or apparatus, and computer program product are provided in the illustrative embodiments for merging two documents that may contain different perspectives and/or bias. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining risk assessment based on assigned protocol values, the method comprising:
generating, by one or more processors, a protocol user interface (UI) element on a graphical user interface, wherein:
the protocol UI element includes an input field and is assigned with a weight value; and
the weight value is determined at least based upon data entered into the input field of the protocol UI element;
adjusting, by one or more processors, the weight value assigned to the protocol UI element based on historical event data associated with a protocol corresponding to the protocol UI element; and
dynamically calculating, by one or more processors, a risk assessment score based on the adjusted weight value, wherein the risk assessment score indicates a likelihood that an adverse event will occur as a result of violating the protocol.

2. The method according to claim 1, wherein the step of adjusting the weight value further comprises:
identifying, by one or more processors, missing portions of the historical event data associated with the protocol; and
adjusting, by one or more processors, the weight value assigned to the protocol UI element as a function of the missing portions of the historical event data.

3. The method according to claim 1, wherein the historical event data comprises a first incident record indicative of a severity of the adverse event corresponding to the violation of the protocol.

4. The method according to claim 3, wherein the historical event data further comprises a second incident record indicative of a number of the adverse events that have occurred in response to the violation of the protocol.

5. The method according to claim 1, wherein the adjusting the weight value assigned to the protocol UI element further comprises utilizing, by one or more processors, a machine learning algorithm.

6. The method according to claim 1, further comprising:
detecting, by one or more processors, that a set of third-party data records retrieved from external databases has been updated, wherein the protocol was generated based on the set of third-party data records;
determining, by one or more processors, updated content of the set of third-party data records; and
adjusting, by one or more processors, the weight value assigned to the protocol UI element by parsing the updated content.

7. The method according to claim 1, wherein the input field comprises a group of Hypertext Markup Language (HTML) elements consisting of: text boxes; radio buttons; drop down menus; buttons; checkboxes; and combinations thereof.

8. A computer program product for determining risk assessment based on assigned protocol values, the computer program product comprising one or more computer readable storage medium and program instructions stored on at least one of the one or more computer readable storage medium, the program instructions comprising:
program instructions to generate a protocol user interface (UI) element on a graphical user interface, wherein:
the protocol UI element includes an input field and is assigned with a weight value; and
the weight value is determined at least based upon data entered into the input field of the protocol UI element;
program instructions to adjust the weight value assigned to the protocol UI element based on historical event data associated with a protocol corresponding to the protocol UI element; and
program instructions to dynamically calculate a risk assessment score based on the adjusted weight value, wherein the risk assessment score indicates a likelihood that an adverse event will occur as a result of violating the protocol.

9. The computer program product according to claim 8, wherein the program instructions to adjust the weight value further comprises:
program instructions to identify missing portions of the historical event data associated with the protocol; and
program instructions to adjust the weight value assigned to the protocol UI element as a function of the missing portions of the historical event data.

10. The computer program product according to claim 8, wherein the historical event data comprises a first incident record indicative of a severity of the adverse event corresponding to the violation of the protocol.

11. The computer program product according to claim 10, wherein the historical event data further comprises a second incident record indicative of a number of the adverse events that have occurred in response to the violation of the protocol.

12. The computer program product according to claim 8, wherein the program instructions to adjust the weight value assigned to the protocol UI element further comprises program instructions to utilize a machine learning algorithm.

13. The computer program product according to claim 8, the program instructions further comprising:
program instructions to detect that a set of third-party data records retrieved from external databases has been updated, wherein the protocol was generated based on the set of third-party data records;
program instructions to determine updated content of the set of third-party data records; and
program instructions to adjust the weight value assigned to the protocol UI element by parsing the updated content.

14. The computer program product according to claim 8, wherein the input field comprises a group of Hypertext Markup Language (HTML) elements consisting of: text boxes; radio buttons; drop down menus; buttons; checkboxes; and combinations thereof.

15. A computer system for determining risk assessment based on assigned protocol values, the computer system comprising one or more processors, one or more computer readable memories, one or more computer readable storage medium, and program instructions stored on at least one of the one or more storage medium for execution by at least one of the one or more processors via at least one of the one or more memories, the program instructions comprising:
program instructions to generate a protocol user interface (UI) element on a graphical user interface, wherein:
the protocol UI element includes an input field and is assigned with a weight value; and
the weight value is determined at least based upon data entered into the input field of the protocol UI element;
program instructions to adjust the weight value assigned to the protocol UI element based on historical event data associated with a protocol corresponding to the protocol UI element; and
program instructions to dynamically calculate a risk assessment score based on the adjusted weight value, wherein the risk assessment score indicates a likelihood that an adverse event will occur as a result of violating the protocol.

16. The computer system according to claim 15, wherein the program instructions to adjust the weight value further comprises:
program instructions to identify missing portions of the historical event data associated with the protocol; and
program instructions to adjust the weight value assigned to the protocol UI element as a function of the missing portions of the historical event data.

17. The computer system according to claim 15, wherein the historical event data comprises a first incident record indicative of a severity of the adverse event corresponding to the violation of the protocol.

18. The computer system according to claim 17, wherein the historical event data further comprises a second incident record indicative of a number of the adverse events that have occurred in response to the violation of the protocol.

19. The computer system according to claim 15, the program instructions further comprising:
program instructions to detect that a set of third-party data records retrieved from external databases has been updated, wherein the protocol was generated based on the set of third-party data records;
program instructions to determine updated content of the set of third-party data records; and
program instructions to adjust the weight value assigned to the protocol UI element by parsing the updated content.

20. The computer system according to claim 15, wherein the input field comprises a group of Hypertext Markup Language (HTML) elements consisting of: text boxes; radio buttons; drop down menus; buttons; checkboxes; and combinations thereof.
